(19) United States
(12) Patent Application Publication
(10) Pub. No.: US 2013/0315531 A1
(43) Pub. Date: Nov. 28, 2013

(54) OPTICAL SEMICONDUCTOR AND OPTICAL MODULE

(71) Applicant: OCLARO JAPAN, INC., Kanagawa (JP)

(72) Inventors: Kohichi Robert TAMURA, Yokohama (JP); Shigetaka HAMADA, Yokohama (JP); Mark JABLONSKI, Tokyo (JP)

(73) Assignee: OCLARO JAPAN, INC., Kanagawa (JP)

(21) Appl. No.: 13/900,819

(22) Filed: May 23, 2013

(30) Foreign Application Priority Data
May 25, 2012 (JP) 2012-120078

(51) Int. Cl. G02B 6/12

(52) U.S. Cl. CPC G02B 6/12
USPC 385/14

(57) ABSTRACT

Provided are an optical semiconductor which includes a pyroelectric first substrate having an optical waveguide formed in a surface thereof and a second substrate connected to the first substrate via an insulating adhesive layer and which inhibits a pyroelectric effect caused therein, and an optical module. The optical semiconductor includes: a first substrate which has an electro-optic effect and is pyroelectric, the first substrate having an optical waveguide formed in an upper surface thereof; a second substrate connected the first substrate via an insulating adhesive layer; a first conductive film formed on a lower surface of the first substrate; and a second conductive film formed on at least one side surface of the first substrate and the second substrate, in which the first conductive film is electrically connected to the second conductive film.

### CROSS-REFERENCE TO RELATED APPLICATION

The present application claims priority from Japanese application JP 2012-120078, filed on May 25, 2012, the content of which is hereby incorporated by reference into this application.

### BACKGROUND OF THE INVENTION

1. Field of the Invention

The present invention relates to an optical semiconductor which includes a pyroelectric substrate that has an electro-optic effect, the substrate having an optical waveguide formed in a surface thereof, and to an optical module.

2. Description of the Related Art

For example, in an optical communication system, an optical semiconductor is used in which an optical waveguide is formed in a surface of a substrate having an electro-optic effect. As the substrate, a crystal with which a great electro-optic effect can be obtained (electro-optic crystal) is used. As the material of the electro-optic crystal, for example, lithiumniobate (hereinafter referred to as LN), lithium tantalate (hereinafter referred to as LT), or lithium niobate-tantalate (hereinafter referred to as LNT) is suitable. JP 2007-101641 A discloses an optical modulator as an example of an optical semiconductor in which an optical waveguide is formed in a surface of a substrate having an electro-optic effect.

### SUMMARY OF THE INVENTION

LN, LT, LNT, or the like which is suitable as the material of an electro-optic crystal is a pyroelectric substance and has a pyroelectric effect. A “pyroelectric effect” as used herein is a phenomenon in which, due to temperature change, static charge is generated on a surface of the crystal, and such charge is referred to as pyroelectric charge. When a modulator substrate is pyroelectric, in order to realize stable device characteristics, it is desired that the pyroelectric charge generated on a surface of the modulator substrate be canceled out to inhibit the generation of effective charge. JP 07-140430 A discloses a technology in which, by forming a conductive film (electrically conductive film) between an upper surface of a substrate in which an optical waveguide is formed and an electrode, pyroelectric charge generated on the upper surface of the substrate is canceled out. When pyroelectric charge is generated on the upper surface of the substrate, charge which cancels out the pyroelectric charge can be generated on the conductive film, which is effective as a measure against pyroelectric charge.

Prior to the present invention, the inventors of the present invention studied an optical semiconductor according to a comparative example of the present invention. The optical semiconductor according to the comparative example is described in the following.

FIG. 6 is a schematic sectional view of the optical semiconductor according to the comparative example of the present invention. FIG. 6 illustrates a waveguide Mach-Zehnder (MZ) modulator in which optical waveguides are formed in a surface of a substrate as an example of the optical semiconductor. As a modulator substrate 110, an electro-optic crystal is used. Two waveguides 113 and 114 are formed in an upper surface of the modulator substrate 110. A buffer layer 122 and a conductive film 123 are stacked in this order above the two waveguides 113 and 114 over the entire region of the upper surface of the modulator substrate 110. A signal electrode 117 is formed in a region over one waveguide 113, while a ground electrode 119 is formed in a region over the other waveguide 114, on an upper side of the conductive film 123. Further, another ground electrode 118 is formed on a side opposite to the ground electrode 119 with respect to the signal electrode 117.

The modulator substrate 110 is processed to be relatively thin, and thus, the mechanical strength thereof is low. Therefore, in order to improve the mechanical strength, a reinforcing substrate 121 is bonded and fixed to a lower surface of the modulator substrate 110 using an adhesive layer 128. In this case, as the reinforcing substrate 121, the same electro-optic crystal as used for the modulator substrate 110 is used. Note that, conductive films 124 and 127 are formed on both side surfaces of the modulator substrate 110 and the reinforcing substrate 121 which are bonded together and on a lower surface of the reinforcing substrate 121, respectively. Further, an electric field developed in the modulator substrate 110 when the optical semiconductor is driven is illustrated in FIG. 6 as electric field lines 140.

The modulator substrate 110 and the reinforcing substrate 121 which are bonded together are hereinafter collectively referred to as the entire substrate. Dielectric polarization caused inside the entire substrate generates pyroelectric charge on surfaces thereof. As described above, the conductive film 124 is formed on the side surfaces of the entire substrate, and the conductive film 127 is formed on the lower surface of the entire substrate (the lower surface of the reinforcing substrate 121), and thus, the pyroelectric charge generated on the surfaces of the entire substrate is canceled out to inhibit the generation of effective charge.

However, further improvement in device characteristics is desired. In order to attain this, it is desired that the influence of the pyroelectric effect over the entire device be further reduced. The inventors of the present invention studied the origin of the pyroelectric effect in the optical semiconductor according to the comparative example, and found that the influence of pyroelectric charge generated in a joint area between the modulator substrate 110 and the reinforcing substrate 121 is not negligible.

FIG. 7 is a schematic sectional view illustrating the pyroelectric effect in the optical semiconductor according to the comparative example. In FIG. 7, a case in which positive pyroelectric charge is generated on the upper surface of the modulator substrate 110 is illustrated. In this case, as described above, negative charge is generated on the conductive film 123 formed over (in proximity to) the upper surface of the modulator substrate 110 so as to cancel out the positive pyroelectric charge. In FIG. 7, positive charge and negative charge which have cancelled out each other are referred to as charge pair 142. Similarly, positive charge is generated on the conductive film 127 formed on the lower surface of the reinforcing substrate 121 so as to cancel out negative charge generated on the lower surface of the reinforcing substrate 121, and positive charge and negative charge which have cancelled out each other are referred to as charge pair 143. Note that, when the pyroelectric charge is generated on side surfaces of the entire substrate, the pyroelectric charge is canceled out by the conductive film 124 as well.

The lower surface of the modulator substrate 110 and the upper surface of the reinforcing substrate 121 are surfaces on which pyroelectric charge is generated. The two surfaces are held in contact with each other via the adhesive layer 128. An insulating adhesive is generally used for the adhesive layer 128, and charge which cancels out pyroelectric charge generated on the two surfaces is not supplied thereto. Therefore, when the temperature changes, pyroelectric charge is generated on the two surfaces, and an electric field which has developed due to the charge remains inside the modulator substrate 110. Thus, an electro-optic effect changes the phase of light which propagates through the waveguides to cause instability of the operating characteristics. FIG. 7 illustrates negative pyroelectric charge 145 which is generated on the lower surface of the modulator substrate 110 and positive pyroelectric charge 146 which is generated on the upper surface of the reinforcing substrate 121.

It is thought that, in order to cancel out the pyroelectric charge generated on the two surfaces, a conductive adhesive is used for the adhesive layer 128. In such a case, charge which cancels out the pyroelectric charge can be generated on the adhesive layer 128 to inhibit the generation of effective charge. However, during the manufacturing steps, the reinforcing substrate 121 is fixed by the adhesive layer 128 before a wafer is divided into chips, and thus, it is necessary to use an adhesive which is suitable for bonding (laminating) the wafer. A wafer has an outside diameter φ of, for example, 50 mm to 125 mm, and thus, in order to realize a thin adhesive layer which has less air bubbles included therein, it is necessary to use an adhesive which has a low viscosity and excellent wettability. However, a conductive adhesive is, for example, a resin prepared by mixing a filler of silver (Ag) or carbon (C) and has low wettability, and thus, it is difficult to realize a thin adhesive layer over a large area.

The present invention has been made in view of such a problem, and an object of the present invention is to provide an optical semiconductor which includes a pyroelectric first substrate having an optical waveguide formed in a surface thereof and a second substrate connected to the first substrate via an insulating adhesive layer and which inhibits a pyroelectric effect caused therein, and an optical module.

(1) In order to solve the above-mentioned problem, according to an exemplary embodiment of the present invention, there is provided an optical semiconductor, including: a first substrate which has an electro-optic effect and is pyroelectric, the first substrate having an optical waveguide formed in an upper surface thereof; a second substrate having an upper surface connected to a lower surface of the first substrate via an insulating adhesive layer; a first conductive film (first electrically conductive film) formed on the lower surface of the first substrate; and a second conductive film (second electrically conductive film) formed on at least one side surface of the first substrate and a side surface of the second substrate corresponding to the at least one side surface, in which the first conductive film is electrically connected to the second conductive film.

(2) In the optical semiconductor according to Item (1), the second substrate may have a thermal expansion coefficient which is substantially the same as a thermal expansion coefficient of the first substrate.

(3) The optical semiconductor according to Item (1) or (2) may further include a third conductive film (third electrically conductive film) formed on the upper surface of the second substrate, and the third conductive film may be electrically connected to the second conductive film.

(4) In the optical semiconductor according to Item (1) or (2), the second substrate may have an electrical conductivity which is higher than an electrical conductivity of the first substrate.

(5) In the optical semiconductor according to Item (3), both a material of the first substrate and a material of the second substrate may be each one selected from the group consisting of lithium niobate, lithium tantalate, and lithium niobate-tantalate.

(6) In the optical semiconductor according to Item (4), a material of the first substrate may be one selected from the group consisting of lithium niobate, lithium tantalate, and lithium niobate-tantalate, and a material of the second substrate may be one selected from the group consisting of black lithium niobate, black lithium tantalate, and black lithium niobate-tantalate.

(7) In the optical semiconductor according to Item (4), a material of the first substrate and a material of the second substrate may be each one combination selected from the group of combinations of lithium niobate and black lithium niobate, lithium tantalate and black lithium tantalate, and lithium niobate-tantalate and black lithium niobate-tantalate.

(8) In the optical semiconductor according to any one of Items (1) to (7), the optical waveguide may function as an LN modulator.

(9) The optical semiconductor according to any one of Items (1) to (8) may further include a buffer layer and a fourth conductive film (fourth electrically conductive film) stacked in this order on the upper surface of the first substrate, the buffer layer and the fourth conductive film covering the optical waveguide, and an electrode in a predetermined shape formed on the fourth conductive film, and the fourth conductive film may be electrically connected to the second conductive film.

(10) In the optical semiconductor according to any one of Items (1) to (3), the second conductive film may be formed on both side surfaces of the first substrate and both side surfaces of the second substrate, and the optical semiconductor may further include a fifth conductive film formed on a lower surface of the second substrate, the fifth conductive film being electrically connected to the second conductive film.

(11) According to an exemplary embodiment of the present invention, there may be provided an optical module, including: the optical semiconductor according to any one of Items (1) to (10) ; and a conductive package for fixedly mounting the optical semiconductor by using a conductive adhesive material, in which the first conductive film is electrically connected to the conductive package.

According to the present invention, the optical semiconductor which includes the pyroelectric first substrate having the optical waveguide formed in the surface thereof and the second substrate connected to the first substrate via the insulating adhesive layer and which inhibits a pyroelectric effect caused therein, and the optical module are provided.

### BRIEF DESCRIPTION OF THE DRAWINGS

In the accompanying drawings:

FIG. 1 is a schematic top view of an optical semiconductor according to a first embodiment of the present invention;

FIG. 2 is a schematic sectional view of the optical semiconductor according to the first embodiment of the present invention;

FIG. 3 is a schematic sectional view illustrating a principal part of the optical semiconductor according to the first embodiment of the present invention;

FIG. 4 is a schematic sectional view illustrating a pyroelectric effect of the optical semiconductor according to the first embodiment of the present invention;

FIG. 5 is a schematic sectional view illustrating a pyroelectric effect of an optical semiconductor according to a second embodiment of the present invention;

FIG. 6 is a schematic sectional view of an optical semiconductor according to a comparative example of the present invention; and

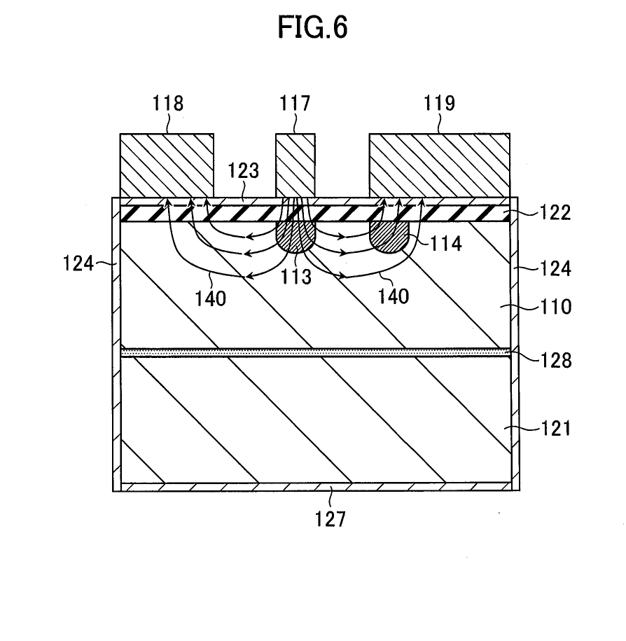

FIG. 7 is a schematic sectional view illustrating a pyroelectric effect of the optical semiconductor according to a comparative example of the present invention.

### DETAILED DESCRIPTION OF THE INVENTION

Embodiments of the present invention are specifically described in detail in the following with reference to the attached drawings. Note that, throughout the figures for illustrating the embodiments, like reference numerals are used to represent members having like functions, and description thereof is omitted for the sake of simplicity. Note that, the drawings referred to in the following are only for illustrating the embodiments byway of examples, and are not necessarily drawn to scale. Further, in the following embodiments, unless otherwise specified, description of the same or similar portions is not repeated as a general rule.

### First Embodiment

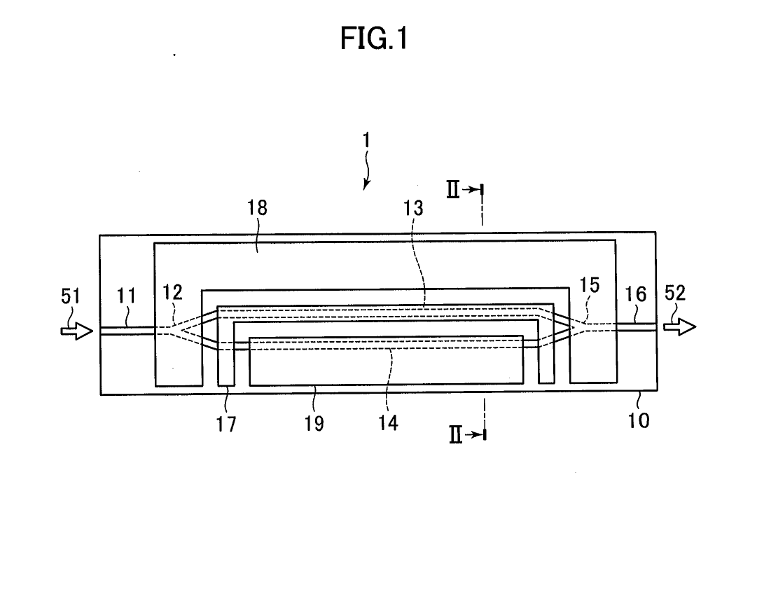

FIG. 1 is a schematic top view of an optical semiconductor 1 according to a first embodiment of the present invention. The optical semiconductor 1 according to this embodiment is a waveguide MZ modulator (LN modulator). The optical semiconductor 1 includes a modulator substrate 10 (first substrate), and optical waveguides are formed in an upper surface of the modulator substrate 10. As the modulator substrate 10, an electro-optic crystal is used. The modulator substrate 10 has an electro-optic effect and is pyroelectric. In order to realize long-distance high-speed optical fiber communication, an optical modulator for modulating an electric data signal into an optical signal is necessary. The optical semiconductor according to this embodiment is most suitable for an optical modulator used for long-distance transmission.

An input optical signal 51 enters an input end of an optical waveguide of the optical semiconductor 1 from the outside. The entering optical signal propagates through an input waveguide 11 and branches to two waveguides 13 and 14 at an input branch waveguide 12. Output sides of the two waveguides 13 and 14 are connected to an output branch waveguide 15. The optical signal further propagates through an output waveguide 16 and an output optical signal 52 exits to the outside from an output end of the optical waveguide. An optical circuit including the above-mentioned optical waveguides forms an MZ optical interference system, and the optical waveguides function as an LN modulator.

In order to realize an optical modulator using an MZ optical interference system, the optical semiconductor 1 includes electrodes for applying an electric signal. The location at which the electrodes are provided depends on the kind of the electro-optic crystal. In this case, as the modulator substrate 10, Z-cut LN (hereinafter referred to as Z-LN) is used, but it goes without saying that the present invention is not limited thereto. Note that, generally LN refers to LiNbO₃, but the present invention is not limited thereto, and LN may also be stoichiometric LN such as LiNbOₓ or LiNb_{y}Oₓ. Specifically, LN as used herein includes stoichiometric LN. The same can be said with regard to other substances such as LT and LNT described below.

When Z-LN is used as the modulator substrate 10, a signal electrode 17 is formed so as to include a region of the upper surface of the modulator substrate 10 over the one waveguide 13. Ground electrodes 18 and 19 are formed on both sides of the signal electrode 17 so as to sandwich the signal electrode 17. The ground electrode 19 is formed so as to include a region over the other waveguide 14, and the ground electrode 18 is formed on a side opposite to the other waveguide 14 with respect to the one waveguide 13. Note that, both ends of the signal electrode 17 and the ground electrode 18 are bent and extended toward a lower edge of FIG. 1 for connection to an external circuit. The signal electrode 17 and the ground electrodes 18 and 19 form RF electrodes. An electric signal is applied to the RF electrodes, and propagates in the same direction as that of an optical signal. Note that, depending on the shapes of the optical waveguide and the electrodes, the optical semiconductor 1 can be used as various kinds of LN modulators such as a light intensity modulator, a phase modulator, and a scrambler. Further, the optical semiconductor 1 according to the present invention is most suitable for an external modulator such as an LN modulator, but the present invention is not limited thereto, and it goes without saying that the present invention is widely applicable to an optical semiconductor including an optical waveguide.

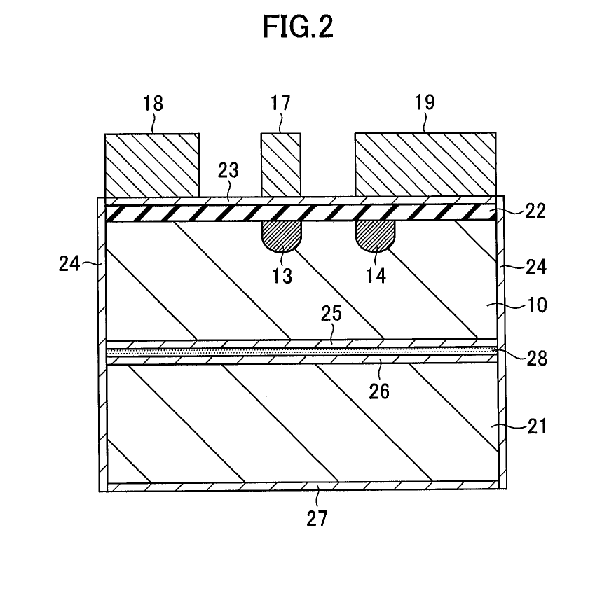

FIG. 2 is a schematic sectional view of the optical semiconductor 1 according to this embodiment. FIG. 2 illustrates a section of the optical semiconductor 1 taken along the line II-II of FIG. 1. As illustrated in FIG. 2, the optical semiconductor 1 includes the modulator substrate 10 (first substrate) and a reinforcing substrate 21 (second substrate). A lower surface of the modulator substrate 10 and an upper surface of the reinforcing substrate 21 are bonded together (connected to each other) via an insulating adhesive layer 28 of an epoxy resin or the like. The modulator substrate 10 and the reinforcing substrate 21 which are bonded together are hereinafter collectively referred to as the entire substrate. A main feature of the present invention resides in that a conductive film 25 (first conductive film) is formed on the lower surface of the modulator substrate 10 and the conductive film 25 is electrically connected to a conductive film 24 (second conductive film). Another feature of the optical semiconductor 1 according to this embodiment resides in that a conductive film 26 (third conductive film) is formed on the upper surface of the reinforcing substrate 21 and the conductive film 26 is electrically connected to the conductive film 24.

When a crystal used as the modulator substrate 10 is LN, an optical waveguide is formed by, for example, thermally diffusing titanium (Ti) or exchanging protons in a predetermined region of the upper surface of the modulator substrate 10. In this case, the two waveguides 13 and 14 are illustrated. Further, a buffer layer 22 and a conductive film 23 (fourth conductive film) are stacked in this order on the entire upper surface of the modulator substrate 10 so as to cover the optical waveguides. When RF electrodes are directly formed on an optical waveguide, the degree of light absorption becomes higher, and thus, a loss increases. The buffer layer 22 is formed of, for example, silicon oxide (SiO₂), and the degree of light absorption of the buffer layer 22 is low (transparent). When the signal electrode 17 and the ground electrodes 18 and 19 are directly formed on an upper surface of an optical waveguide, due to interaction between light and a metal, light is attenuated to increase the optical loss of an output optical signal. By providing the buffer layer 22 between an optical waveguide and RF electrodes, the optical loss is inhibited. Further, when an electric signal (modulating signal) is applied to the signal electrode 17, the buffer layer 22 enables the propagation speed of the electric signal to conform to the propagation speed of light which propagates through the waveguide 13, and thus, impedance matching can be established. Further, the signal electrode 17 and the ground electrodes 18 and 19 in predetermined shapes as illustrated in FIG. 1 are formed on an upper surface of the conductive film 23. These RF electrodes are formed by stacking, for example, Ti, gold (Au), and Au plating in this order from the upper surface of the conductive film 23.

The conductive film 24 is formed on both side surfaces of the entire substrate, and a conductive film 27 (fifth conductive film) is formed on a lower surface of the entire substrate, that is, a lower surface of the reinforcing substrate 21. In this case, the conductive films 23, 24, 25, 26, and 27 are formed of polycrystalline silicon (poly-Si), p-type silicon (Si) doped with phosphorus (P), n-type Si doped with boron (B), or the like, and are conductive. Note that, a “conductive” substance as used herein does not mean that the substrate is limited to a good conductor but it is enough that the substrate is electrically conductive to a degree in which charge necessary for inhibiting pyroelectric charge caused in the substrate can be supplied therethrough. Note that, a conductive antireflection film (AR film) (not shown) is formed on each of end faces of the optical semiconductor 1 illustrated in FIG. 1, that is, on the input side (left side) and on the output side (right side) of an optical signal. By forming the conductive films 23, 24, and 27 and the AR films on the surfaces of the substrate, the conductive films 23, 24, and 27 (and the AR film) are electrically connected to one another. Further, the conductive films 25 and 26 formed in the entire substrate are also held in contact with the conductive film 24, and all of these conductive films and the AR film are electrically connected to one another.

Now the operating principle of the optical semiconductor 1 is described. The input optical signal 51 which enters from the outside propagates through the input waveguide 11, and branches to the two waveguides 13 and 14 at the input branch waveguide 12. The branch ratios depend on the structure of the input branch waveguide 12, but, generally, a structure in which the input optical signal branches equally into the two waveguides 13 and 14 is used. In this case, half of the input optical signal 51 propagates through each of the two waveguides 13 and 14. When the branched optical signals are combined by the output branch waveguide 15, interference of light occurs. When optical signals output from the two waveguides 13 and 14, respectively, are in phase (that is, when a phase difference Δφ is zero between optical signals which propagate through the two waveguides, respectively), constructive interference occurs and an intense optical signal is output from the output branch waveguide 15 to the output waveguide 16. On the other hand, when optical signals output from the two waveguides 13 and 14 are in opposite phase (Δφ=π), destructive interference occurs and light which exits to the output waveguide 16 is extinguished. Therefore, by changing Δφ, the output optical signal 52 which exits to the outside can be changed. Generally, when an optical waveguide is formed of an electro-optic crystal, by applying a voltage to the electro-optic crystal from the outside, due to the electro-optic effect of the electro-optic crystal, the phase of an optical signal which propagates through the electro-optic crystal can be changed.

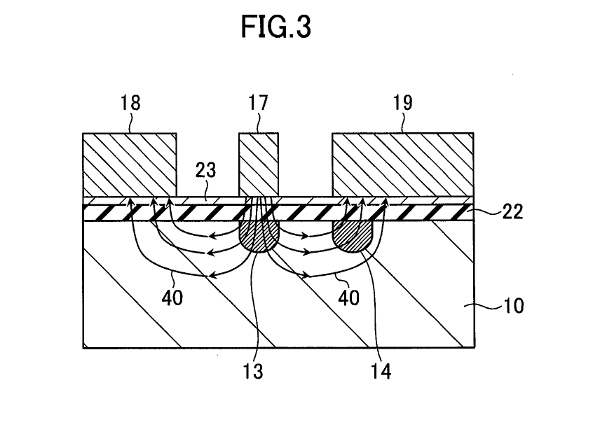

FIG. 3 is a schematic sectional view illustrating a principal part of the optical semiconductor 1 according to this embodiment. An electric field which develops when a voltage V is applied to the signal electrode 17 is illustrated in FIG. 3 as electric field lines 40. In this case, a vertical direction in the plane of FIG. 3 is referred to as Z direction, and a downward direction is referred to as +Z direction. As illustrated in FIG. 3, the electric field lines 40 pass through the waveguide 13 in the +Z direction and pass through the waveguide 14 in the −Z direction. The feature of an electro-optic crystal resides in that a refractive index n of the crystal is changed by an electric field E from the outside (electro-optic effect). The relationship between the refractive index n and the electric field E can be expressed as n=γE, where γ is an electro-optic constant. Δφ is proportional to n=γE, and thus, modulation of an optical signal can be realized by applying the voltage V from the outside. When the voltage applied from the outside is a data signal, the data signal is modulated into an optical signal to realize optical transmission.

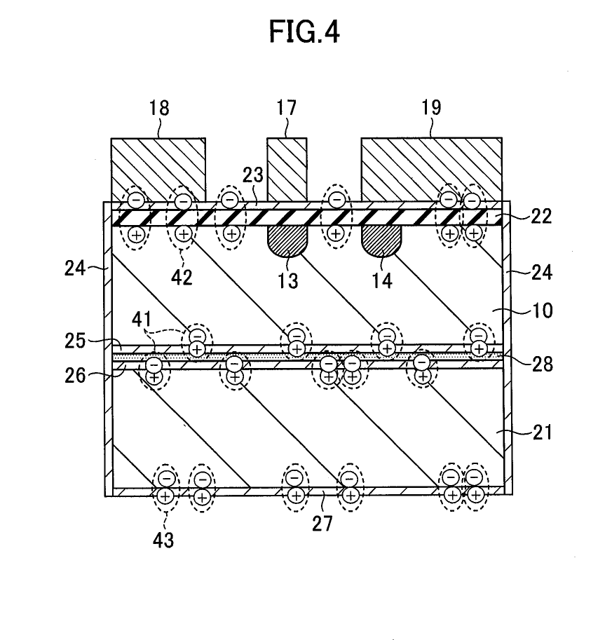

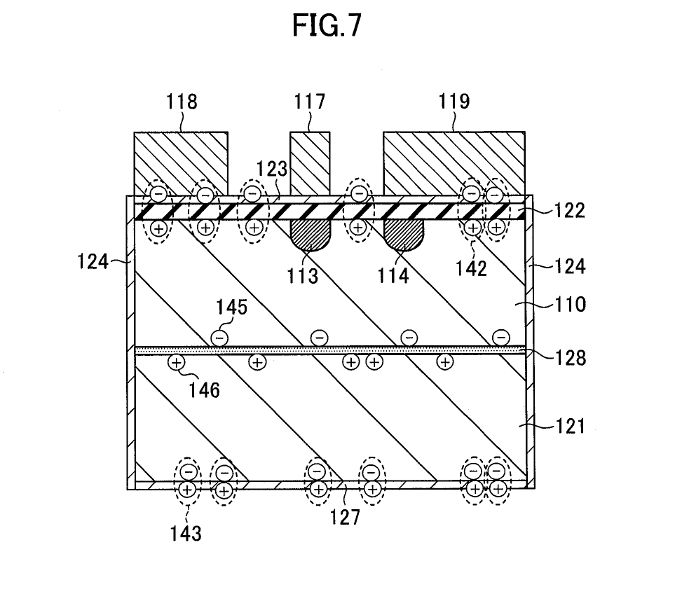

FIG. 4 is a schematic sectional view illustrating a pyroelectric effect of the optical semiconductor 1 according to this embodiment. Similarly to the case illustrated in FIG. 7, a case in which positive pyroelectric charge is generated on the upper surface of the modulator substrate 10 is illustrated. As described above, the feature of the present invention resides in that the conductive film 25 is formed on the lower surface of the modulator substrate 10 and the conductive film 25 is electrically connected to the conductive film 24. In accordance with the positive pyroelectric charge generated on the upper surface of the modulator substrate 10, negative pyroelectric charge is generated on the lower surface of the modulator substrate 10. However, positive charge is generated on the conductive film 25 so as to cancel out the negative pyroelectric charge. Further, as described above, another feature of the optical semiconductor 1 according to this embodiment resides in that the conductive film 26 is formed on the upper surface of the reinforcing substrate 21 and the conductive film 26 is electrically connected to the conductive film 24. In accordance with the negative pyroelectric charge generated on the lower surface of the modulator substrate 10, positive pyroelectric charge is generated on the upper surface of the reinforcing substrate 21. However, negative charge is generated on the conductive film 26 so as to cancel out the positive pyroelectric charge. Positive charge and negative charge which have canceled out each other in a joint area between the modulator substrate 10 and the reinforcing substrate 21 are referred to as charge pairs 41 in FIG. 4.

In the optical semiconductor 1 according to this embodiment, an insulating adhesive is used for the adhesive layer 28. If the conductive films 25 and 26 are not formed, charge for canceling out the pyroelectric charge generated on the lower surface of the modulator substrate 10 and on the upper surface of the reinforcing substrate 21 is not supplied. However, in the optical semiconductor 1 according to this embodiment, the conductive films 25 and 26 are formed, which are each electrically connected to the conductive film 24. For example, via the signal electrode 17 and the ground electrodes 18 and 19, charge which cancels out the pyroelectric charge generated on the two surfaces is supplied, the pyroelectric charge generated on the two surfaces are canceled out, and the generation of effective charge is inhibited.

Similarly, negative charge is generated on the conductive film 23 formed over (in proximity to) the upper surface of the modulator substrate 10 so as to cancel out the positive pyroelectric charge generated on the upper surface of the modulator substrate 10. The conductive film 23 is held in contact with the signal electrode 17 and the ground electrodes 18 and 19, and thus, it is desired that the resistance of the conductive film 23 be high to the extent that the signal electrode 17 and the ground electrodes 18 and 19 are not short-circuited, and the resistance of the conductive film 23 be low (the electrical conductivity of the conductive film 23 be high) to the extent that the conductive film 23 can supply charge for cancelling out the pyroelectric charge. Further, positive charge is generated on the conductive film 27 formed on the lower surface of the reinforcing substrate 21 so as to cancel out negative pyroelectric charge generated on the lower surface of the reinforcing substrate 21. Further, charge is generated on the conductive film 24 formed on the both side surfaces of the entire substrate so as to cancel out pyroelectric charge generated on the both side surfaces. Positive charge and negative charge which have canceled out each other on the upper surface and the lower surface of the entire substrate are referred to as charge pairs 42 and 43, respectively, in FIG. 4.

The optical semiconductor 1 according to this embodiment has a structure in which, not only the pyroelectric charge generated on the surfaces of the entire substrate, but also the pyroelectric charge generated inside the entire substrate is canceled out, and thus, effective charge generated in the entire substrate is inhibited.

An electric field which develops due to pyroelectric charge in the entire substrate is inhibited, and thus, even when the temperature changes, a phase shift in light which propagates through the waveguides is inhibited to realize stable modulating operation.

Note that, from the viewpoint of sufficiently canceling out the pyroelectric charge generated on the upper surface of the reinforcing substrate 21, it is desired that the conductive film 26 be formed, but the conductive film 26 is not necessarily required. Even when the conductive film 26 is not formed, the conductive film 25 formed in proximity to the upper surface of the reinforcing substrate 21 can cancel out the pyroelectric charge generated on the upper surface of the reinforcing substrate 21, and the effect of the present invention can be obtained. Further, the conductive films 25 and 26 can also cancel out charge generated on surfaces of the adhesive layer 28.

The modulator substrate 10 is generally formed of a wafer having a thickness of 0.2 to 0.5 mm. In general, the dimensions of the modulator substrate 10 after being diced are 20 to 90 mm in length and 0.5 to 3 mm in width, and thus, the modulator substrate 10 is in an elongated shape. In order to enhance the mechanical strength of the thin modulator substrate 10, the reinforcing substrate 21 is bonded to the modulator substrate 10. In this case, in order to obtain the more stable bonding of the modulator substrate 10 to the reinforcing substrate 21 when the temperature of the modulator substrate 10 changes, it is desired that the thermal expansion coefficient of the reinforcing substrate 21 be as close as possible to the thermal expansion coefficient of the modulator substrate 10. In this case, the material of the modulator substrate 10 is Z-LN, and the thermal expansion coefficient of Z-LN is about 15 ppm which is a large value, and thus, by using Z-LN as the material of the reinforcing substrate 21 as well, the thermal expansion coefficient of the modulator substrate 10 can be the same as the thermal expansion coefficient of the reinforcing substrate 21. Both the material of the modulator substrate 10 and the material of the reinforcing substrate 21 may be X-cut LN and both of them may be LT, or LNT. However, the modulator substrate 10 and the reinforcing substrate 21 are not limited to being formed by the same crystal cut of the same electro-optic crystal insofar as the modulator substrate 10 and the reinforcing substrate 21 have substantially the same thermal expansion coefficient. “Having substantially the same thermal expansion coefficient” as used herein means that the thermal expansion coefficient of the reinforcing substrate 21 is in a range of ±10% of the thermal expansion coefficient of the modulator substrate 10. It is more desired that the thermal expansion coefficient of the reinforcing substrate 21 be in a range of ±5% of the thermal expansion coefficient of the modulator substrate 10.

Further, in the optical semiconductor 1 according to this embodiment, the conductive film 24 is formed on the both side surfaces of the entire substrate. This is for the purpose of supplying with more stability charge to the conductive films 25 and 26 from the outside. However, when charge sufficiently moves, the conductive film may be formed only on one side surface. When charge sufficiently moves only with the AR film, no conductive film may be formed on the side surfaces of the entire substrate. One side surface of the entire substrate as used here in means one side surface of the modulator substrate 10 and a side surface of the reinforcing substrate 21 corresponding to the one side surface of the modulator substrate 10. In this case, as described above, the resistance of the conductive film 23 is required to be high to the extent that the signal electrode 17 and the ground electrodes 18 and 19 are not short-circuited. Insofar as this is satisfied, the conductive film 23 may be formed of other substances having the electrical conductivity which is high to the extent that charge can be supplied therethrough. Further, unlike the conductive film 23, limitations are not imposed on the other conductive films 24, 25, 26, and 27. The conductive films 24, 25, 26, and 27 may be formed of other substances having the electrical conductivity which is high to the extent that charge can be supplied therethrough, and, from the viewpoint of supplying charge with more stability, a substance having a higher electrical conductivity is desired.

### Second Embodiment

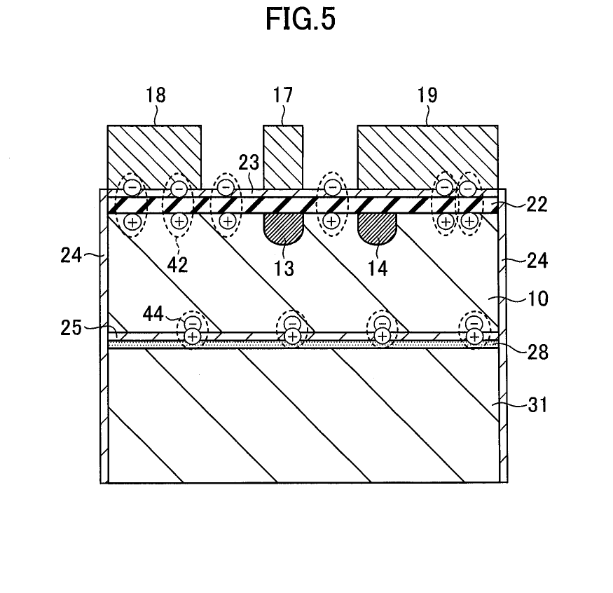

FIG. 5 is a schematic sectional view illustrating a pyroelectric effect of an optical semiconductor 1 according to a second embodiment of the present invention. The optical semiconductor 1 according to this embodiment has the same structure as that of the optical semiconductor 1 according to the first embodiment except for the structure of a reinforcing substrate 31.

As the reinforcing substrate 31 according to this embodiment, black LN (hereinafter referred to as BLN) is used. The thermal expansion coefficient of BLN is substantially the same as the thermal expansion coefficient of LN. Note that, BLN is a substance formed by removing oxygen from ordinary LN. Oxygen can be removed from LN by, for example, annealing LN at 450° C. to 750° C. in any one of a vacuum atmosphere, a nitrogen gas atmosphere, and an inert gas atmosphere. By removing oxygen from LN, the color of LN changes from transparent to opaque black. BLN has an electrical conductivity higher than that of LN. BLN is a crystal having many defects, and thus, it is not suitable for being used as the modulator substrate 10. However, BLN inhibits the generation of static charge due to pyroelectric charge, and thus, is suitable for being used as the reinforcing substrate 31. It is desired that the resistivity of BLN be, for example, any one of values in a wide range of 9×10⁹ to 1×10¹³ (Ohm·cm) at room temperature of 25° C. It is enough that the resistivity of BLN is at least lower than the resistivity of ordinary LN (typically 1.3×10¹⁴ (Ohm·cm)). In other words, it is enough that the electrical conductivity of BLN is at least higher than the electrical conductivity of ordinary LN. Further, it is desired that the resistivity of BLN be 1/100 or less of the resistivity of LN (the electrical conductivity of BLN be 100 times or more as high as the electrical conductivity of LN). Note that, BLN is not limited to LN from which oxygen is removed, and may be LN having, for example, Fe (iron) or the like added thereto.

By using BLN as the reinforcing substrate 31, pyroelectricity of the reinforcing substrate 31 is inhibited, and pyroelectric charge generated on the surfaces of the reinforcing substrate 31 is inhibited. Therefore, pyroelectric charge on the surfaces of the reinforcing substrate 31 is not illustrated in FIG. 5. With regard to the inside of the entire substrate, pyroelectric charge is generated on the lower surface of the modulator substrate 10, but, similarly to the case of the first embodiment, charge which cancels out the pyroelectric charge is generated on the conductive film 25. Positive charge and negative charge which have canceled out each other on the lower surface of the modulator substrate 10 are referred to as charge pair 44 in FIG. 5. Further, the reinforcing substrate 31 has a high electrical conductivity, and thus, a conductive film is not formed on the lower surface of the reinforcing substrate 31.

The optical semiconductor 1 according to this embodiment has a structure in which, similarly to the case of the first embodiment, the pyroelectric charge generated inside the entire substrate is canceled out, and thus, effective charge generated in the entire substrate is inhibited. By using a material having a high electrical conductivity as the reinforcing substrate 21, inhibition of the pyroelectric effect of the entire substrate is further realized, and thus, an outstanding effect is obtained. An electric field which develops due to the pyroelectric charge in the entire substrate is inhibited, and thus, even when the temperature changes, a phase shift in light which propagates through the waveguides is inhibited so as to realize more stable modulating operation.

The material of the reinforcing substrate 31 is not limited to BLN. It is enough that the material has a thermal expansion coefficient which is substantially the same as that of the modulator substrate 10 and has an electrical conductivity which is higher than that of the modulator substrate 10. The material of the reinforcing substrate 31 may be, other than BLN, black LT (hereinafter referred to as BLT), or black LNT (hereinafter referred to as BLNT). Further, when the modulator substrate 10 is formed of LN, it is desired that the reinforcing substrate 31 be formed of BLN, when the modulator substrate 10 is formed of LT, it is desired that the reinforcing substrate 31 be formed of BLT, and, when the modulator substrate 10 is formed of LNT, it is desired that the reinforcing substrate 31 be formed of BLNT. The reason why it is desired that the material of the modulator substrate 10 and the material of the reinforcing substrate 31 be any one of a combination of LN and BLN, a combination of LT and BLT, and a combination of LNT and BLNT in this case is that the thermal expansion coefficients in the respective combinations are close enough to each other to be regarded as substantially the same.

### Third Embodiment

An optical module according to a third embodiment of the present invention is an optical module (not shown) including the optical semiconductor 1 according to the first or second embodiment and a conductive package. The optical semiconductor 1 is fixed to the package by using a conductive adhesive material so as to be mounted thereon. In the optical semiconductor 1 according to the first embodiment, the conductive film 27 is formed on the lower surface of the reinforcing substrate 21. Further, in the optical semiconductor 1 according to the second embodiment, the reinforcing substrate 31 has a high electrical conductivity. Therefore, a conductive film formed in the optical semiconductor 1 is electrically connected to the package. This enables charge to be supplied with more stability to the conductive film 25 formed on the lower surface of the modulator substrate 10 from the outside via the package, which further enhances the effect of the present invention.

The optical semiconductor and the optical module according to the present invention are described above. The present invention is not limited to the optical semiconductor and the optical module described above, and is widely applicable to an optical semiconductor including a first substrate which has an electro-optic effect and is pyroelectric, the first substrate having an optical waveguide formed in an upper surface thereof, and a second substrate bonded to the first substrate, and to an optical module including the optical semiconductor.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An optical semiconductor, comprising:
a first substrate which has an electro-optic effect and is pyroelectric, the first substrate having an optical waveguide formed in an upper surface thereof;
a second substrate having an upper surface connected to a lower surface of the first substrate via an insulating adhesive layer;
a first conductive film formed on the lower surface of the first substrate; and
a second conductive film formed on at least one side surface of the first substrate and a side surface of the second substrate corresponding to the at least one side surface,
wherein the first conductive film is electrically connected to the second conductive film.

2. The optical semiconductor according to claim 1, wherein the second substrate has a thermal expansion coefficient which is substantially the same as a thermal expansion coefficient of the first substrate.

3. The optical semiconductor according to claim 1, further comprising a third conductive film formed on the upper surface of the second substrate,
wherein the third conductive film is electrically connected to the second conductive film.

4. The optical semiconductor according to claim 1, wherein the second substrate has an electrical conductivity which is higher than an electrical conductivity of the first substrate.

5. The optical semiconductor according to claim 3, wherein both a material of the first substrate and a material of the second substrate are each one selected from the group consisting of lithium niobate, lithium tantalate, and lithium niobate-tantalate.

6. The optical semiconductor according to claim 4, wherein:
a material of the first substrate is one selected from the group consisting of lithium niobate, lithium tantalate, and lithium niobate-tantalate; and
a material of the second substrate is one selected from the group consisting of black lithium niobate, black lithium tantalate, and black lithium niobate-tantalate.

7. The optical semiconductor according to claim 4, wherein a material of the first substrate and a material of the second substrate are each one combination selected from the group of combinations of lithium niobate and black lithium niobate, lithium tantalate and black lithium tantalate, and lithium niobate-tantalate and black lithium niobate-tantalate.

8. The optical semiconductor according to claim 1, wherein the optical waveguide functions as an LN modulator.

9. The optical semiconductor according to claim 1, further comprising:
a buffer layer and a fourth conductive film stacked in this order on the upper surface of the first substrate, the buffer layer and the fourth conductive film covering the optical waveguide; and
an electrode in a predetermined shape formed on the fourth conductive film,
wherein the fourth conductive film is electrically connected to the second conductive film.

10. The optical semiconductor according to claim 1, wherein:
the second conductive film is formed on both side surfaces of the first substrate and both side surfaces of the second substrate; and
the optical semiconductor further comprises a fifth conductive film formed on a lower surface of the second substrate, the fifth conductive film being electrically connected to the second conductive film.

11. An optical module, comprising:
the optical semiconductor according to claim 1; and
a conductive package for fixedly mounting the optical semiconductor by using a conductive adhesive material,
wherein the first conductive film is electrically connected to the conductive package.
